(19) United States
(12) Patent Application Publication
(10) Pub. No.: US 2009/0276855 A1
(43) Pub. Date: Nov. 5, 2009

(54) Method, apparatus, and computer program product that provide for presentation of event items

(75) Inventors: Marko Anderson, Helsinki (FI); Kari Virtanen, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/112,004

(22) Filed: Apr. 30, 2008

(51) Int. Cl. G06F 21/00; G06F 15/16

(52) U.S. Cl. 726/26; 709/201

(57) ABSTRACT

An apparatus that provides for presentation of event items may include a processor. The processor may be configured to receive mobile event items from a mobile terminal. In this regard, the mobile event items may be determined based on a context of the mobile terminal. The processor may be further configured to receive service event items, and provide for presentation of the mobile event items and the service event items in an event item object. The processor may also be configured to provide for presentation of the mobile event items and the service event items, where the mobile event items are filtered based upon the content of the mobile event items or security attributes. Associated methods and computer program products may also be provided.

### TECHNICAL FIELD

Embodiments of the present invention relate generally to providing for the presentation of information and, more particularly, relate to an apparatus, method and a computer program product that provide for presentation of event items.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices and other computing devices. However, as the ease of information transfer increases, users continue to demand more and different types of information. Mobile devices, networks, personal computers, and other computing devices can now capture numerous types of information about users and their activities. Such information may include location information, phone call information (e.g., what contacts were called, duration of calls, what calls were received), status information (e.g., working, sleeping, watching a movie), media information (e.g., recent photographs taken, music played), etc. The availability of this information is desirable to users, not only with respect to information about themselves and their own activities, but also with respect to their friends and business contacts.

Currently, these and other types of information are being captured by various computing devices, but the information often goes unused since no common outlet for the information is available to users. Further, due to the lack of a common outlet for the information, the information cannot be shared with other users on a network. As such, users cannot consider, utilize, or interact with the information to, for example, make decisions regarding activities performed by the users.

As such, it would be desirable to provide mechanisms for aggregating user information that is captured by various computing devices associated with the user. Moreover, it would be desirable to provide the information in a usable form for consideration and interaction by a user. In this same regard, it would be desirable to provide the ability to share a user's captured information with other users and allow the other users to view and interact with the information.

### BRIEF SUMMARY

A method, apparatus, and computer program product are therefore provided that provide for presentation of event items in an event item object. In this regard, exemplary embodiments of the present invention receive mobile event items from a mobile terminal. The mobile event items may be determined based on a context of the mobile terminal. Exemplary embodiments may further receive service event items, and provide for presentation of the mobile event items and the service event items in an event item object. Exemplary embodiments may also provide for presentation of the mobile event items and the service event items, where the mobile event items are filtered based upon the content of the mobile event items or upon security attributes.

In one exemplary embodiment, a method that provides for presentation of event items is described. The method may include receiving mobile event items from a mobile terminal. In this regard, the mobile event items may be determined based on a context of the mobile terminal. The method may further include receiving service event items and providing for presentation of the mobile event items and the service event items in an event item object.

In another exemplary embodiment, a computer program product that provides for presentation of event items is described. The computer program product may include at least one computer-readable storage medium having computer-readable program code portions stored therein. The computer-readable program code portions may include a first program code portion, a second program code portion, and a third program code portion. The first program code portion may be configured to receive mobile event items from a mobile terminal. In this regard, the mobile event items may be determined based on a context of the mobile terminal. The second program code portion may be configured to receive service event items, and the third program code portion may be configured to provide for presentation of the mobile event items and the service event items in an event item object.

In another exemplary embodiment, an apparatus that provides for presentation of event items is described. The apparatus may include a processor. The processor may be configured to receive mobile event items from a mobile terminal. In this regard, the mobile event items may be determined based on a context of the mobile terminal. The processor may be further configured to receive service event items, and provide for presentation of the mobile event items and the service event items in an event item object.

In one exemplary embodiment, an apparatus that provides for presentation of event items is described. The apparatus may include means for receiving mobile event items from a mobile terminal. In this regard, the mobile event items may be determined based on a context of the mobile terminal. The apparatus may further include means for receiving service event items and means for providing for presentation of the mobile event items and the service event items in an event item object.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 illustrates a block diagram showing an apparatus that provides for presentation of event items with associated network connectivity according to an exemplary embodiment of the present invention;

FIGS. 3a and 3b illustrate exemplary presentations of event items according to exemplary embodiments of the present invention;

FIG. 4 is a flowchart according to an exemplary method that provides for presentation of event items according to an exemplary embodiment of the present invention;

FIG. 5 is a flowchart according to an exemplary method that provides for presentation of event items according to an exemplary embodiment of the present invention;

FIGS. 6a and 6b illustrate exemplary presentations of event items according to exemplary embodiments of the present invention; and

FIG. 7 illustrates an exemplary system of network entities according to exemplary embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

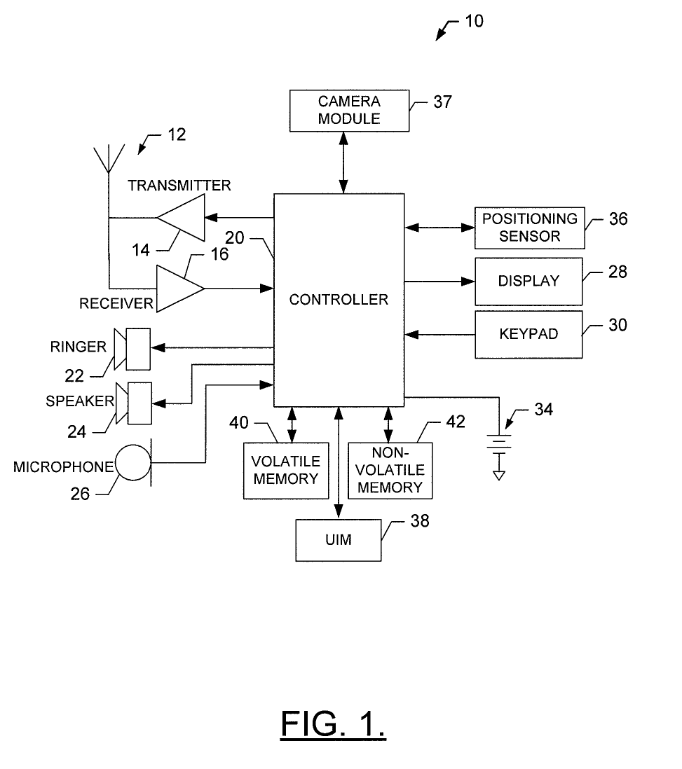

FIG. 1, one aspect of the invention, illustrates a block diagram of a mobile terminal 10 that would benefit from, and may be an exemplary apparatus of, embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the apparatus and method of embodiments of the present invention will be primarily described in conjunction with mobile communications applications. It should be understood, however, that the apparatus and method of embodiments of the present invention can be utilized in conjunction with a variety of other applications, both in the mobile communications industries and outside of the mobile communications industries.

The mobile terminal 10 may include an antenna 12 (or multiple antennas) in operable communication with a transmitter 14 and a receiver 16. The mobile terminal 10 may further include an apparatus, such as a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9 generation (3.9G) wireless communication protocols, such as Evolved Universal Terrestrial Radio Access Network (E-UTRAN), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

The mobile terminal 10 may further include a positioning sensor 36 such as, for example, a global positioning system (GPS) module in communication with the controller 20. The positioning sensor 36 may be any means, device or circuitry for locating the position of mobile terminal 10. The positioning sensor 36 may include all hardware for locating the position of a mobile terminal 10. Alternatively or additionally, the positioning sensor 36 may utilize a memory device of the mobile terminal 10 to store instructions for execution by the controller 20 in the form of software necessary to determine the position of the mobile terminal 10. Although the positioning sensor 36 of this example may be a GPS module, the positioning sensor 36 may include or otherwise alternatively be embodied as, for example, an assisted global positioning system (Assisted-GPS) sensor, or a positioning client, which may be in communication with a network device to receive and/or transmit information, such as a sky or floor sensor, for use in determining a position of the mobile terminal 10. In this regard, the position of the mobile terminal 10 may be determined by GPS, as described above, cell ID, signal triangulation, or other mechanisms as well. In one exemplary embodiment, the positioning sensor 36 includes a pedometer or inertial sensor. As such, the positioning sensor 36 may be capable of determining a location of the mobile terminal 10, with respect to, for example, longitudinal and latitudinal directions, and altitude direction of the mobile terminal 10, or a position relative to a reference point such as a destination or start point. Information from the positioning sensor 36 may then be communicated to a memory of the mobile terminal 10 or to another memory device to be stored as a position history or location information. Additionally, the positioning sensor 36 may be capable of utilizing the controller 20 to transmit/receive, via the transmitter 14/receiver 16, location information such as the position of the mobile terminal 10.

In some embodiments, the mobile terminal 10 includes a media capturing element, such as a camera, video and/or audio module, in communication with the controller 20. The media capturing element may be any means for capturing images, video and/or audio for storage, display or transmission. For example, in an exemplary embodiment in which the media capturing element is a camera module 37, the camera module 37 may include a selective capture mode where camera module 37 can form and save a digital image file from an image captured by camera module 37. In some embodiments, the camera module 37 can implement a preview mode where the current view from the camera module's optical hardware is displayed on, for example, display 28. In some embodiments, image data captured during preview mode is not saved for longevity, but rather continuously overwritten in order to depict the current view from the optical hardware. Additionally, while in preview mode a delay can exist due to, for example, hardware and software constraints. As such, a display of the current view of camera module 37 can be a display of the view from camera module 37 at a time in past that can be described by the current time minus the delay.

As such, the camera module 37 can include all hardware, such as a lens or other optical component(s), and software necessary for creating a digital image file from a captured image, in the selective capture mode, or for displaying the current view of the camera module, in a preview mode. Camera module 37 may also include all hardware, such as a lens or other optical component(s), and software necessary to provide image zooming functionality. Image zooming functionality can include the ability to magnify or de-magnify an image prior to or subsequent to capturing an image. Image zooming functionality can be used in selective capture mode and preview mode.

In either selective capture mode or preview mode, camera module 37 can operate in conjunction with positioning sensor 37 and orientation module 39 to associate the location and orientation information of mobile terminal 10, at the moment of image capture. In some embodiments, a subset of the location and orientation information of mobile terminal 10, at the moment of image capture, can be utilized. Similarly, a zoom level, indicating the degree that camera module 36 is zoomed at the moment of image capture, can be associated with a digital image file. For example, in preview mode, in some embodiments, a set of location information, orientation information and zoom level can be associated with each captured image frame, or at some lesser interval in which a common set of information is associated with each image frame captured within the interval. In some embodiments, the zoom level can include information regarding the aspect ratio of a captured image.

Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processor or co-processor which assists the controller 20 in processing image data and an encoder and/or decoder for compressing and/or decompressing image data. The encoder and/or decoder may encode and/or decode according to, for example, a joint photographic experts group (JPEG) standard or other format.

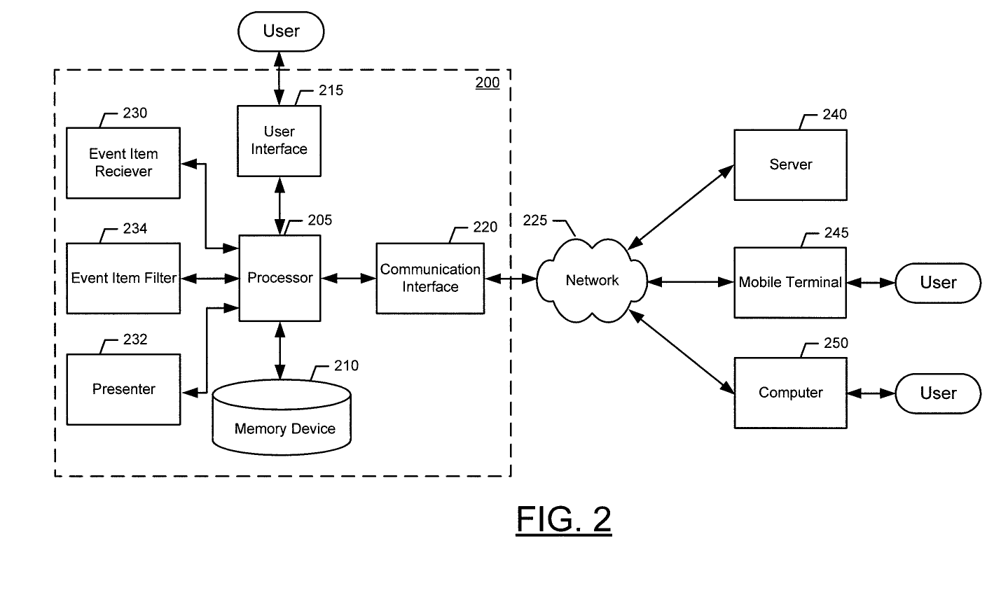

Referring now to FIG. 2, an apparatus 200 that provides for the presentation of event items is described. Apparatus 200 may be embodied as a server or other network device including, for example, a mobile terminal, such as mobile terminal 10 of FIG. 1. The apparatus 200 may include or otherwise be in communication with a processor 205, a user interface 215, a communication interface 220, and a memory device 210. The memory device 210 may include, for example, volatile and/or non-volatile memory (e.g., volatile memory 40 and/or non-volatile memory 42). The memory device 210 may be configured to store information, data, applications, instructions or the like for enabling the apparatus to carry out various functions in accordance with exemplary embodiments of the present invention. For example, the memory device 210 could be configured to buffer input data for processing by the processor 205. Additionally or alternatively, the memory device 210 could be configured to store instructions for execution by the processor 205. As yet another alternative, the memory device 210 may be one of a plurality of databases that store information in the form of static and/or dynamic information, for example, in association with mobile event items, service event items, security parameters, content parameters, or the like.

The processor 205 may be embodied in a number of different ways. For example, the processor 205 may be embodied as a microprocessor, a coprocessor, a controller (e.g., controller 20 from FIG. 1), or various other processing means or elements including integrated circuits such as, for example, an ASIC (application specific integrated circuit) or FPGA (field programmable gate array). In an exemplary embodiment, the processor 205 may be configured to execute instructions stored in the memory device 210 or otherwise accessible to the processor 205.

The user interface 215 may be in communication with the processor 205 to receive an indication of a user input at the user interface 215 and/or to provide an audible, visual, mechanical, or other output to the user. As such, the user interface 215 may include, for example, a keyboard, a mouse, a joystick, a touch screen display, a conventional display, a microphone, a speaker, or other input/output mechanisms. In an exemplary embodiment in which the apparatus 200 is embodied as a server, the user interface 215 may be limited, or even eliminated.

The communication interface 220 may be embodied as any device or means embodied in either hardware, software, or a combination of hardware and software that is configured to receive and/or transmit data from/to a network and/or any other device or module in communication with the apparatus 200. In this regard, the communication interface 220 may include, for example, an antenna, a transmitter, a receiver, a transceiver and/or supporting hardware and/or software for enabling communications with network 225, which may be any type of wired or wireless network. Via the communication interface 220 and the network 225, the apparatus 200 may communicate with the server 240, the mobile terminal 245, and/or the computer 250.

The server 240 may be any type of computing device for storing, retrieving, computing, transmitting, and receiving data. The server 240 may include a memory device, a processor, and a communication interface for communicating with the network 225. In some embodiments, the server 240 may be a web server, database server, file server, or the like.

The mobile terminal 245 may also be any type of device for storing, retrieving, computing, transmitting and receiving data. In some embodiments, mobile terminal 245 may be embodied as a mobile terminal 10 of FIG. 1.

The computer 250 may also be any type of computing device for storing, retrieving, computing, transmitting, and receiving data. The computer 250 may include a memory device, a processor, user interface for presenting output to a user and receiving input from a user, and a communication interface for communicating with the network 225. In some embodiments, the computer 250 may be a personal computer capable of running applications including web-browsers, widgets, or other applications, which may or may not involve the transmission/reception of data to/from the network 225. Via the computer 250, a user may access an exemplary online service using a browser or a dedicated application.

The event item receiver 230 and the presenter 232 of apparatus 200 may be any means or device embodied in hardware, software, or a combination of hardware and software that is configured to carry out the functions of the event item receiver 230 and the presenter 232, respectively, as described herein. In an exemplary embodiment, the processor 205 may include, or otherwise control the event item receiver 230 and/or the presenter 232. In various exemplary embodiments, the event item receiver 230 and the presenter 232 may reside on a server, or other network device including a mobile terminal, such as mobile terminal 10 of FIG. 1.

In some embodiments, the system of FIG. 2 may be utilized for synchronization of data amongst the various network platforms. In this regard, the network platforms (i.e., the apparatus 200, the server 240, the mobile terminal 245, the computer 250, etc.) may be used by a user to access data. In some embodiments, the network platforms may be used to access data associated with an online service account. Any type of data may be synchronized amongst the platforms and made available for access. Types of data may include status information, content, user profile information, shared files (e.g., documents, photos, media content, etc.), mobile event items, service event items, event item objects, or the like. For example, a contacts list may be accessed and/or synchronized (i.e., updated) via the mobile terminal 245, the computer 250, the server 240, or the apparatus 200. Upon modifying the contacts list, the new information may be transmitted to a data storage device (e.g., the apparatus 200 or the server 240) or otherwise made available to the various network platforms for subsequent access.

In this manner, data modified on one platform may be available to another platform. For example, the modified contact information may be automatically transmitted from the mobile terminal 245 to the server 240 or the apparatus 200 for synchronization purposes. As such, the user may later access the modified contact information via computer 250 and/or a browser.

In some embodiments, a user may set synchronization parameters, which may identify types of data that should be synchronized and types of data that need not be synchronized. For example, a user may set the synchronization parameters to synchronize the contact list, but may also set the synchronization parameters such that user profile information need not be synchronized. In various embodiments, various mobile event items service event items, and/or event item object may or may not be synchronized.

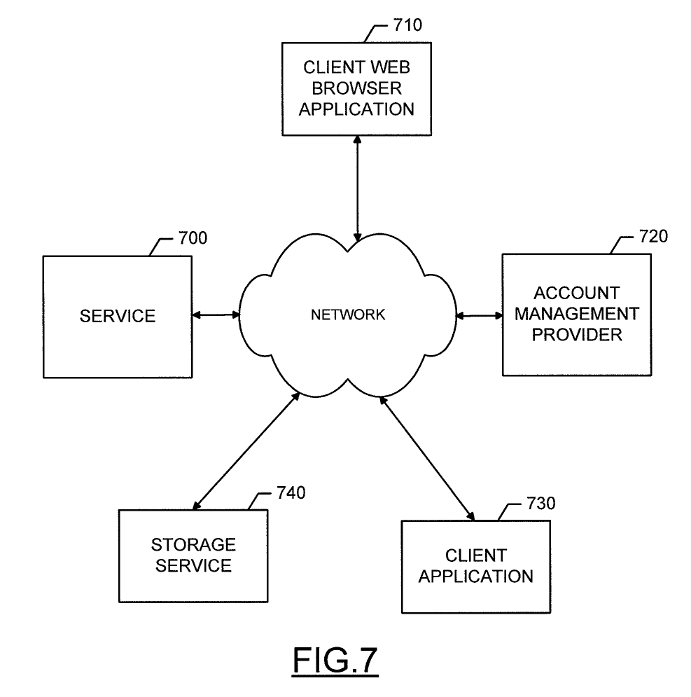

In this regard, and referring now to FIG. 7, an embodiment of a system in accordance with aspects of the present invention is illustrated. The system of FIG. 7 includes a service 700, a client web browser application 710, an account management provider 720, a client application 730, and a storage service 740. The service 700, the client web browser application 710, the account management provider 720, the client application 730, and the storage service 740 may be interconnected via the illustrated network, which may operate in the same manner as network 225.

The service 710, the account management provider 720, and the storage service 740 may collectively represent an embodiment of the apparatus 200 of FIG. 2. In this regard, the service 710 may represent an internet or network service (e.g., a website, a social networking website, a blog website, a web feed, a widget, or the like) that may receive and interact with event items in a manner described with respect to the event item receiver 230, the event item filter 232, the presenter 232, and the processor 205. Various types of data, such as, but not limited to, event items, may be synchronized with and/or otherwise transferred to and from the service 700. The service 700 may utilize the storage service 740 for storage and retrieval of data by the service 700. In various embodiments, the storage service 740 may operate in the same manner as the memory device 210 and/or the server 240. Further, the account management provider 720 may operate together with the various other network entities to perform account management and security features. In some embodiments, login information and passwords are first directed to the account management provider 720 for verification. Upon verification, the account management provider 720 may provide access to, and allow communications between, various network entities using, for example, a token or other access key.

Client application 730 may be a software or hardware application residing and operating on a platform, such as a computer, mobile terminal, or the like, that may be used to interact with the service 700. In some embodiments, the client application 730 may reside and operate on the apparatus 200, the mobile terminal 245, the computer 250, or the like, and may operate in the same manner as apparatus 200, the mobile terminal 245, the computer 250, or the like. The client application may be downloaded to and/or installed on the platform. In some embodiments, the client application 730 may be specifically tailored to interact with the service 700. Via the client application 730, the platform, and the user of the platform, may interact with the service 700 to send and receive data, such as event items, between the client application 730 and the service 700. The client application 730 may facilitate the gathering and storage of event items and other data for subsequent transmission to the service 700.

Similar to the client application 730, the client web browser application 710 may be a software or hardware application residing and operating on a platform, such as a computer, mobile terminal, or the like, that may be used to interact with the service 700. In this regard, the client web browser application 710 may be a generic network communication application for interacting with various network entities, including the service 700. In some embodiments, the client web browser application 710 may reside and operate on the apparatus 200, the mobile terminal 245, the computer 250, or the like, and may operate in the same manner as the apparatus 200, the mobile terminal 245, the computer 250, or the like. Via the client web browser application 710, the platform, and the user of the platform, may interact with the service 700 to send and receive, as well as synchronize, data, such as event items, between the client web browser application 710 and the service 700. The client web browser application 710 may facilitate the gathering and storage of usage attributes for subsequent transmission to the service 700.

Referring back to FIG. 2, the event item receiver 230 may be configured to receive mobile event items. Means for receiving mobile event items may include the processor 205, the event item receiver 230, a receiver, algorithms for receiving mobile event items described herein and/or the like. The event item receiver 230 or the processor 205 may also be configured to store the event items on the memory device 2 10. In some embodiments, the mobile event items may be received from a mobile terminal, such as the mobile terminal 245. A mobile event item may be associated with a context of the mobile terminal. In this regard, a mobile terminal may capture mobile event items associated with the context of the mobile terminal as the events or activities associated with the mobile event items are occurring. The mobile terminal, such as the mobile terminal 245, may also transmit the mobile event items to the apparatus 200 and the event item receiver 230. In this regard, the event item receiver may associate the received mobile event items with a user and/or a user account.

In some embodiments, a change in the context of the mobile terminal may define a mobile event item. The context of a mobile terminal may be a description of the operations currently being performed by the mobile terminal, or a status associated with the mobile terminal. As such, a change in the operations being performed by the mobile terminal, or a change in the status of the mobile terminal may define a mobile event item. Further, a change in attributes associated with operations (e.g., user initiated changes in attributes), of the mobile terminal may define a mobile event item. For example, the context of a mobile terminal may include whether the mobile terminal is currently handling a communication channel (e.g., phone call, email, text message, instant message, etc.). In this regard, mobile event items may include indications of changes with respect to the communication channel, such as initiating a communication (e.g., initiating a phone call, preparing an email, preparing a text message, preparing an instant message, etc.), receiving a communication, or ending a communication (e.g., ending the phone call, sending the email, sending the text message, sending the instant message, etc.).

The context of a mobile terminal may additionally or alternately be based on the applications currently being performed by the mobile terminal. For example, the context of a mobile terminal may be based on whether a user is playing a game, interacting with a media item (e.g., a photo, music track, video, etc.), capturing a media item on the mobile terminal, or the like. Accordingly, mobile event items in this regard may be defined when an application is initiated, or when an application is closed. In some embodiments, performing actions within the application may also define mobile event items including, for example, accessing, downloading, uploading, storing, or sharing information, reaching a high score, accomplishing a task, or the like.

Further, the context of a mobile terminal may additionally or alternatively be based on the location of the mobile terminal. In some embodiments, information regarding the location of the mobile terminal may be captured by a positioning sensor, such as the positioning sensor 36 of mobile terminal 10. In this regard, mobile event items may be defined when a mobile terminal moves. In some embodiments, mobile event items may be defined when location information associated with the mobile terminal changes, or the location information describes a predefined location (e.g., Hawaii, Europe, a football stadium, a restaurant, a place of work, home, etc.).

In some instances, the context of a mobile terminal may additionally or alternatively be based on a current profile setting of the mobile terminal. Profile settings may include, for example, loud, silent, vibrate, meeting, and the like. In this regard, mobile event items may be defined when a mobile terminal is changed to a new profile setting.

The context of a mobile terminal may also be based on various additional or alternative operations performed by the mobile terminal (e.g., modifying a contact list, web-browsing, etc.) and statuses (e.g., battery level, network reception level, etc.) associated with the mobile terminal. As such, additional or alternative mobile event items may also be defined in these regards.

The event item receiver 230 may also be configured to receive service event items. Means for receiving service event items may include the processor 205, the event item receiver 230, a receiver, algorithms for receiving service event items described herein and/or the like. The service event items may be associated with an internet or network service, and received from a server, such as the server 240, a mobile terminal, such as the mobile terminal 245, a computer, such as the computer 250, or the like. Service event items may be indications of activities performed by a user while logged into an online service (e.g., a social networking website) and within the constraints of the online service. In contrast, in some embodiments, mobile event items may be captured with respect to activities and operations that occur outside of an online service. In this regard, an online service may be a social networking website, or any type of website that provides sharing of information between users. A user may log into the online service and perform activities such as define relationships (i.e., add friends to a friends list), modify personal profile information (e.g., upload a new profile picture, enter a new favorite movie in their profile, change a personal status, etc.), post communications on other user's webpage, join social groups within the online service, and the like. These and other activities may define service event items.

The presenter 232 may be configured to provide for presentation of the mobile event items and the service event items (collectively referred to as event items) in an event item object. Means for providing for presentation of the event items in an event item object may include the processor 205, the presenter 232, a display, algorithms for providing for presentation of the event items in an event item object described herein and/or the like. The presenter 232 may provide for presentation of the mobile event items and the service event items in an event item object to the user interface 215, or via the network 225 to the server 240, to the mobile terminal 245, or to the computer 250. In this regard, an event item object may be frame, window, widget, area of a webpage, or other medium that can be used to present event items. In addition to providing for presentation of event items in an event item object, presenter 232 may analyze the content of the event items and modify, or condition, the content of the event item prior to providing for presentation of the event item. Presenter 232 may also associate the event item with a user or user account to provide for presentation of the event items with an indication of the user or user account. Further, in some embodiments, a time stamp may be associated with event items and the presenter 232 may provide for presentation of the time stamp with the event items. In some embodiments, text associated with the event items may be listed in an event item object. The text associated with the event item may be listed together with an indication of the user or user account that is associated with the event item.

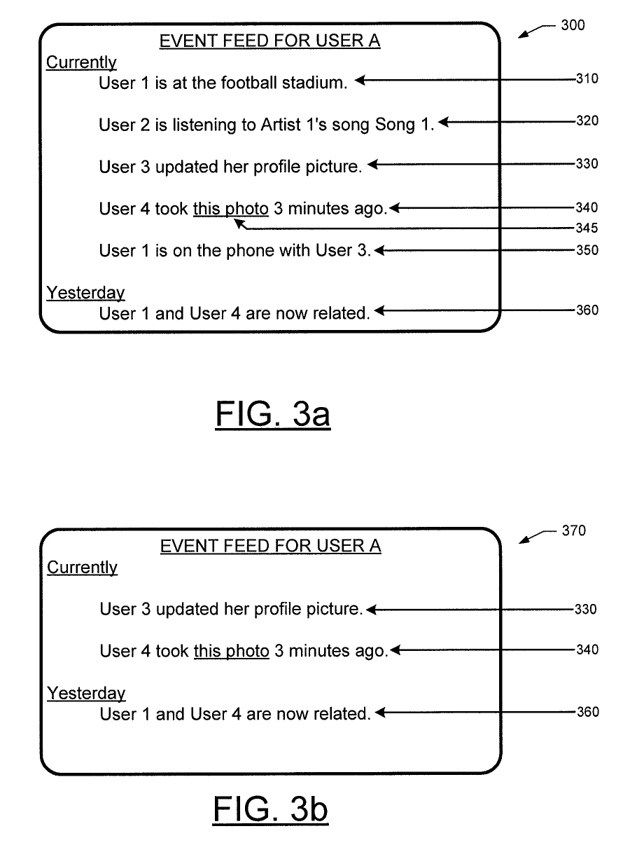

FIG. 3a depicts an exemplary presentation of mobile event items and service event items within an event item object 300. As indicated in FIG. 3a , the event item object 300 is being presented to User A. In this regard, User A may have logged into an online service, such as a social networking website, and an event feed (i.e., the event item object 300) has been presented to User A.

The listing of event items within the event item object 300 includes a mobile event item 310 indicating that User 1 is at the football stadium. In this regard, User 1's mobile terminal may have captured its change in location, via, for example, the positioning sensor 36, as a mobile event item. User 1's mobile terminal may have transmitted the mobile event item (i.e., the new location information) to be received by the event item receiver 230 and associated the mobile event item with User 1 or User 1's account. The presenter 232 may have then analyzed the location information of the mobile event item and determined that the location information described a location in the football stadium. The presenter 232 may have modified the media content item to include information that the described location is within the football stadium. The presenter 232 may have then provided for presentation of the mobile event item 310 within the event item object 300.

The listing of event items within the event item object 300 includes a mobile event item 320 indicating that User 2 is currently listening to Artist 1's song Song 1. In this example, it is assumed that User 2 is listening to Song 1 from User 2's mobile terminal and therefore playing Song 1 may be a mobile event item. However, another example may include User 2 listening to Song 1 from within an online service and, in that example, playing Song 1 may be a service event item. User 2's mobile terminal may have captured a mobile event item when User 2 began playback of Song 1. User 2's mobile terminal may have transmitted the mobile event item (i.e., starting playback of Song 1) to be received by the event item receiver 230 and associated the mobile event item with User 2 or User 2's account. The presenter 232 may have then provided for presentation of the mobile event item 320 within the event item object 300.

The listing of event items within the event item object 300 also includes an service event item 330 indicating that User 3 updated her profile picture. In this example, User 3 has logged into an online service and uploaded a new photo to her profile webpage, and as such, the actions of User 3 may define an service event item. The platform (e.g., the apparatus 200, the mobile terminal 245, the computer 250, the server 240, or the like) that User 3 used to upload the photo may have captured the uploading of the photo as an service event item and transmitted the service event item to be received by the event item receiver 230 and associated the service event item with User 3 or User 3's account. The presenter 232 may have then provided for presentation of the service event item 330 within the event item object 300.

The listing of event items within the event item object 300 includes a mobile event item 340 indicating that User 4 may have taken a photo 3 minutes ago and provides a link 345 to the photo. In this example, User 4 took a photo using, for example, the camera module 37 of mobile terminal 10. User 4's mobile terminal may have captured a mobile event item when User 4 took the photo. User 4's mobile terminal may have transmitted the mobile event item (i.e., taking of the photo) to be received by the event item receiver 230 and associated the mobile event item with User 4 or User 4's account. User 4's mobile terminal may have also transmitted the photo to the apparatus 200 or another location to be accessible via the link 345. The presenter 232 may have then analyzed a time stamp associated with the mobile event item and determined a time since the photo was taken (i.e., 3 minutes ago) to be presented with the mobile event item. The presenter 232 may have then provided for presentation of the mobile event item 340 within the event item object 300.

The listing of event items within the event item object 300 includes a mobile event item 350 indicating that User 1 is on the phone with User 3. In this regard, User 1's mobile terminal may have captured the initiation of a phone call by User 1's mobile terminal (or, in another example, User 3's mobile terminal may have captured the reception of a phone call). User 1's mobile terminal may have transmitted the mobile event item (i.e., the initiation of the phone call) to be received by the event item receiver 230, and associated the mobile event item with User 1 or User 1's account. The presenter 232 may have then analyzed the content of the mobile event item, which may include the called number, and associated the called number with User 3. The presenter 232 may have modified the media content item to include information that the called mobile terminal is associated with User 3 or User 3's account. The presenter 232 may have then provided for presentation of the mobile event item 350 within the event item object 300.

The listing of event items within the event item object 300 also includes an service event item 360 indicating that User 1 and User 4 are now related. In this example, User 1 has logged into an online service and accepted an invitation provided by User 4 to be related. The platform (e.g., the apparatus 200, the mobile terminal 245, the computer 250, the server 240, or the like) that User 1 used to accept the relationship may have captured the acceptance as an service event item, transmitted the service event item to be received by the event item receiver 230, and associated the service event item with User 1 or User 1's account. The presenter 232 may have then provided for presentation of the service event item 360 within the event item object 300.

Referring back to FIG. 2, the apparatus 200 may optionally include an event item filter 234. The event item filter 234 of apparatus 200 may be any means or device embodied in hardware, software, or a combination of hardware and software that is configured to carry out the functions of the event item filter 234 as described herein. In an exemplary embodiment, the processor 205 may include, or otherwise control the event item filter 234. In various exemplary embodiments, the event item filter 234 may reside on a server, or other network device including a mobile terminal, such as mobile terminal 10 of FIG. 1.

The event item filter 234 may be configured to filter mobile event items based on various criteria. Means for filtering mobile event items may include the processor 205, the event item filter 234, algorithms for filtering mobile event items described herein and/or the like. In this regard, particular mobile event items received by the event item receiver 230 may be removed from the received mobile event items by the event item filter 234 based on the filtering criteria. After filtering, the media items that are to be presented may be the filtered mobile event items and the media items that are not to be presented may be the filtered out, or removed, mobile event items.

In some exemplary embodiments, the event item filter 234 may be configured to filter mobile event items based on security parameters. Accordingly, in these exemplary embodiments, the presenter 232 may be configured to provide for presentation of the filtered mobile event items. The security parameters may be predefined rules that can be compared against the mobile event items to determine if a mobile event item should be removed. In this regard, a user of an online service may configure security parameters such that particular mobile event items captured by the user's mobile terminal and received by event item receiver 230 are removed from the mobile event items such that the removed mobile event items are not provided for presentation and the remaining, filtered mobile event items are provided for presentation.

In some embodiments, the event item filter 234 may be configured with security parameters that have been defined to remove mobile event items on a user or user account basis. In this regard, security parameters may be defined that indicate users or user accounts that are presented mobile event items, or alternatively users or user account that may not be presented mobile event items. For example, security parameters may be defined such that a user or user account that is a friend of a first user may be presented with mobile event items about the first user, but a user or user account that is a stranger to the first user may not be presented with mobile event items about the first user. In this regard, a friend or stranger may be defined within an online service, such as a social networking service.

Additionally, or alternatively, in some embodiments, event item filter 234 may be configured with security parameters that have been defined to remove categories of mobile event items (i.e., mobile event categories). In this regard, mobile event categories may be defined such that a mobile event item may be associated with one or more categories. Some exemplary categories may include location-related mobile events, call-related mobile events, application-related mobile events, or the like. As a result, filtering of the received mobile event items may be performed on a category level. For example, if security parameters are defined with respect to a category defined as location-related mobile events, then the event item filter 234 may remove, from the received mobile events items, mobile event items that indicate the location of a mobile terminal. As a result, the presenter 232 need not provide for presentation of the removed location-related mobile events, and as such the location-related mobile events may be excluded from presentation in the event item object.

Additionally, or alternatively, in some embodiments, event item filter 234 may be configured with security parameters that have been defined based on the context of a mobile terminal. In this regard, the context (as described above) may be used to determine the security parameters. For example, if the location of a mobile terminal is at the user's place of work a first predefined set of security parameters may be implemented. Further, when the mobile terminal is placed in a particular status (e.g., silent), a second set of security parameters may be implanted. In this regard, based on the context of the mobile terminal, mobile event items may be removed from the received mobile event items by event item filter 234.

Additionally or alternatively, in some embodiments, the event item filter 234 may be configured to filter mobile event items based on the content of the mobile event items when content parameters are applied. The motivation for using content parameters and content based filtering may be to present a user with interesting and relevant activities. In some embodiments, content parameters may be a type, or sub-set, of security parameters. In this regard, content parameters may be defined such that mobile event items that include content describing, for example, a particular location, or content describing a particular artist of a media content item, the mobile event item may be removed by the event item filter 234 and not provided for presentation by the presenter 232.

In some embodiments, in addition to residing in apparatus 200, where apparatus 200 is embodied as a server, the event item receiver 230, the presenter 232, and the event item filter 234, or functional portions of the event item receiver 230, the presenter 232, and the event item filter 234 may also reside on a server such as server 240. Similarly, the functionality of the event item receiver 230, the presenter 232, and the event item filter 234 may reside on any network entity.

FIG. 3b depicts an exemplary presentation of mobile event items and service event items within an event item object 370, where the event item object 370 of FIG. 3b depicts an exemplary filtered version of the presentation of mobile event items and service event items within an event item object 300 of FIG. 3a . In this regard, the event item filter 234 has filtered received mobile event items based on security and/or content parameters such that the presenter 232 may provide for presentation of the filtered mobile event items. As indicated in FIG. 3b , the event item object 370 is being presented to User A. In this regard, User A may have logged into an online service, such as a social networking website, and an event feed (i.e., event item object 370) has been presented to User A.

The listing of event items within the event item object 370 includes service event items 330, mobile event item 340, and internet service 360, but mobile event item 310, mobile event item 320, mobile event item 350 have been excluded due to security or content parameters. Mobile event item 340 is included in the list of event items, because User 4 has not defined any security or content parameters that remove mobile event 340.

In the exemplary list of event items of FIG. 3b , mobile event item 310 has been excluded as a result of example security parameters defined by User 1. User 1 has defined security parameters such that the category of location-related event items are removed by the event item filter 234. As such, the mobile event item 310, indicating that User 1 is currently at the football stadium, is not presented.

Mobile event 320 has been excluded from the event item listing of FIG. 3b , as a result of example content parameters defined by User 2. User 2 has defined content parameters such that mobile event items including the content “Artist 1,” are to be removed by the event item filter 234. As such, the mobile event item 320, indicating that User 2 is currently listening to Song 1 by Artist 1 is not presented.

Mobile event 350 has been excluded from the event item listing of FIG. 3b , as a result of example security parameters defined by User 1. User 1 has defined security parameters associated with the context of User 1's mobile terminal such that when the context of User 1's mobile terminal includes location information describing a location within the football stadium, mobile event items in a category of call-related event items are to be removed by the event item filter 234. As such, the mobile event item 350, indicating that User 1 is currently on the phone with User 3 is not presented because User 1's mobile terminal is currently located at the football stadium.

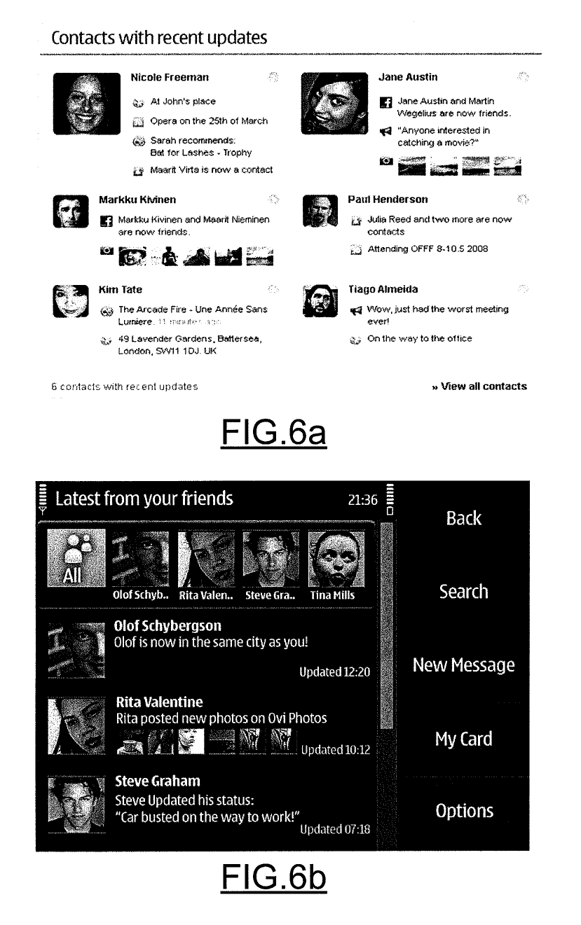

FIGS. 6a and 6b illustrate additional exemplary presentations of event items according to exemplary embodiments of the present invention. The exemplary presentation of FIG. 6a may be utilized with a webpage view on, for example, a browser or other application on a computer, such as computer 250. The exemplary presentation of FIG. 6a is organized by entity (e.g., Nicole Freeman, Jane Austin, etc.) and provides event items in an area associated with the entity. The event items of the exemplary presentation of FIG, 6a are also associated with personal photos, icons, and the like. FIG. 6b is a similar exemplary presentation of event items that may be utilized on a mobile terminal.

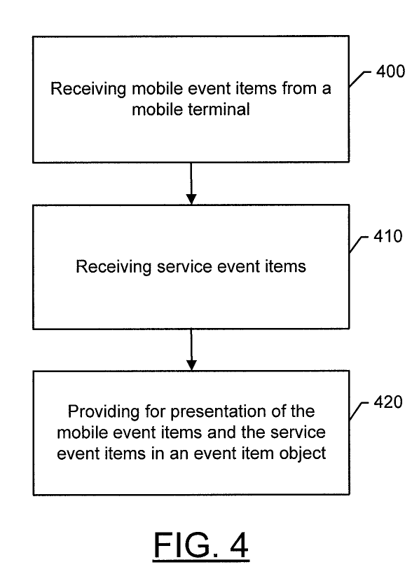

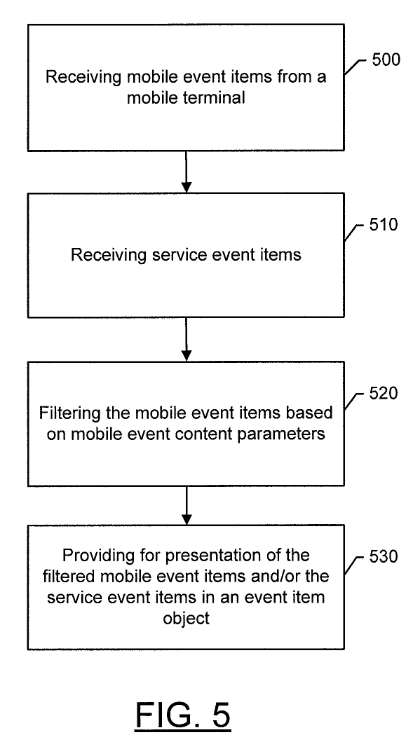

FIGS. 4 and 5 are flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions, or executable program code portions. For example, one or more of the procedures described above may be embodied by computer program instructions. In this regard, the computer program instructions which embody the procedures described above may be stored by a memory device of the apparatus and executed by a processor in the apparatus. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one exemplary embodiment of a method that provides for presentation of event items as illustrated in FIG. 4 may include receiving mobile event items from a mobile terminal at 400. In this regard, mobile event items may be determined based on a context of the mobile terminal. In some embodiments, the context of the mobile terminal may include the location of the mobile terminal and/or the operations currently being performed by the mobile terminal. Additionally, or alternatively, each received mobile event item may be associated with one or more mobile event categories. The exemplary embodiment of a method that provides for presentation of event items as illustrated in FIG. 4 may also include receiving internet service events at 410, and providing for presentation of the mobile event items and the service event items in an event item object at 420.

Another exemplary embodiment of a method that provides for presentation of event items as illustrated in FIG. 5 may include receiving mobile event items from a mobile terminal at 500. In this regard, the mobile event items may be determined based on a context of the mobile terminal. In some embodiments, the context of the mobile terminal may include the location of the mobile terminal and/or the operations currently being performed by the mobile terminal. Additionally, or alternatively, each received mobile event item may be associated with one or more mobile event categories. The exemplary embodiment of a method as provided in FIG. 5 may also include receiving internet service events at 510.

In an exemplary embodiment, the method may also include additional optional operations. In such embodiments, mobile event items may be filtered based on content parameters at 520. Additionally, or alternatively, in some embodiments, mobile event items may be filtered based on security parameters. The exemplary embodiment of a method as provided in FIG. 5 may also include providing for presentation of filtered mobile event items and the service event items in an event item object at 530.

In some embodiments, the filtering may be performed on mobile event categories of mobile event items. Further, in some embodiments, the security parameter used in filtering may be defined based on the context of a mobile terminal. Additionally, or alternatively, in some embodiments, security parameters may be defined that indicate user accounts that are presented with the mobile event items.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving mobile event items from a mobile terminal, the mobile event items determined based on a context of the mobile terminal;
receiving service event items; and
providing for presentation of the mobile event items and the service event items in an event item object.

2. The method of claim 1 further comprising:
filtering the mobile event items based on content parameters; and
wherein providing for presentation of the mobile event items and the service event items includes providing for presentation of filtered mobile event items.

3. The method of claim 1 further comprising:
filtering the mobile event items based on security parameters; and
wherein providing for presentation of the mobile event items and the service event items includes providing for presentation of the filtered mobile event items.

4. The method of claim 3, wherein receiving mobile event items includes receiving mobile event items, each mobile event item being associated with one or more mobile event categories; and wherein filtering the mobile event items includes filtering the mobile event items based on security parameters associated with the mobile event categories, and the filtering being performed on mobile event categories.

5. The method of claim 3, wherein filtering the mobile event items based on security parameters includes the security parameters being defined based on the context of the mobile terminal.

6. The method of claim 3, wherein filtering the mobile event items based on security parameters includes filtering the mobile event items based on security parameters, the security parameters indicating user accounts that are presented the mobile event items.

7. The method of claim 1, wherein receiving mobile event items includes receiving mobile event items, the mobile event items determined based on the context of the mobile terminal, the context of the mobile terminal including the location of the mobile terminal.

8. The method of claim 1, wherein receiving mobile event items includes receiving mobile event items, the mobile event items determined based on the context of the mobile terminal, the context of the mobile terminal including operations currently being performed by the mobile terminal.

9. A computer program product comprising at least one computer-readable storage medium having computer-readable program code portions stored therein, the computer-readable program code portions comprising:
a first program code portion configured to receive mobile event items from a mobile terminal, the mobile event items determined based on a context of the mobile terminal;
a second program code portion configured to receiving service event items; and
a third program code portion configured to provide for presentation of the mobile event items and the service event items in an event item object.

10. The computer program product of claim 9, wherein the computer-readable program code portions further comprise:
a fourth program code portion configured to filter the mobile event items based on content parameters; and
wherein the third program code portion being configured to provide for presentation of the mobile event items and the service event items includes being configured to providing for presentation of the filtered mobile event items.

11. The computer program product of claim 9, wherein the computer-readable program code portions further comprise:
a fourth program code portion configured to filter the mobile event items based on security parameters; and
wherein the third program code portion being configured to provide for presentation of the mobile event items and the service event items includes being configured to provide for presentation of the filtered mobile event items.

12. The computer program product of claim 11, wherein the first program code portion configured to receive mobile event items includes being configured to receive mobile event items, each mobile event item being associated with one or more mobile event categories; and wherein the fourth program code portion being configured to filter the mobile event items includes being configured to filter the mobile event items based on security parameters associated with the mobile event categories, and the filtering being performed on the mobile event categories.

13. The computer program product of claim 11, wherein the fourth program code portion configured to filter the mobile event items includes being configured to filter the mobile event items based on security parameters, the security parameters being defined based on the context of the mobile terminal.

14. The computer program product of claim 11, wherein the fourth program code portion configured to filter the mobile event items includes being configured to filter the mobile event items based on security parameters, the security parameters indicating user accounts that are presented the mobile event items.

15. The computer program product of claim 9, wherein the first program code portion configured to receive mobile event items includes being configured to receive mobile event items, the mobile event items determined based on the context of the mobile terminal, the context of the mobile terminal including the location of the mobile terminal.

16. The computer program product of claim 9, wherein the first program code portion configured to receive mobile event items includes being configured to receive mobile event items, the mobile event items determined based on the context of the mobile terminal, the context of the mobile terminal including operations currently being performed by the mobile terminal.

17. An apparatus comprising a processor, the processor configured to:
receive mobile event items from a mobile terminal, the mobile event items determined based on a context of the mobile terminal;
receive service event items; and
provide for presentation of the mobile event items and the service event items in an event item object.

18. The apparatus of claim 17, the processor further configured to:
filter the mobile event items based on content parameters; and
wherein the processor being configured to provide for presentation of the mobile event items and the service event items includes being configured to provide for presentation of filtered mobile event items.

19. The apparatus of claim 17, the processor further configured to:
filter the mobile event items based on security parameters; and
wherein the processor being configured to provide for presentation of the mobile event items and the service event items includes being configured to provide for presentation of the filtered mobile event items.

20. The apparatus of claim 19, wherein the processor being configured to receive mobile event items includes being configured to receive mobile event items, each mobile event item being associated with one or more mobile event categories; and wherein the processor being configured to filter the mobile event items includes being configured to filter the mobile event items based on security parameters associated with the mobile event categories, and the filtering being performed on mobile event categories.

21. The apparatus of claim 19, wherein the processor being configured to filter the mobile event items includes being configured to filter the mobile event items based on security parameters, the security parameters being defined based on the context of the mobile terminal.

22. The apparatus of claim 19, wherein the processor being configured to filter the mobile event items based on security parameters includes being configured to filter the mobile event items based on security parameters, the security parameters indicating user accounts that are presented the mobile event items.

23. The apparatus of claim 17, wherein the processor being configured to receive mobile event items includes being configured to receive mobile event items, the mobile event items determined based on the context of the mobile terminal, the context of the mobile terminal including the location of the mobile terminal.

24. The apparatus of claim 17, wherein the processor being configured to receive mobile event items includes being configured to receive mobile event items, the mobile event items determined based on the context of the mobile terminal, the context of the mobile terminal including operations currently being performed by the mobile terminal.

25. The apparatus of claim 17 further comprising a memory device, and wherein the processor is further configured to store the mobile event items in the memory device.

26. An apparatus comprising:
means for receiving mobile event items from a mobile terminal, the mobile event items determined based on a context of the mobile terminal;
means for receiving service event items; and
means for providing for presentation of the mobile event items and the service event items in an event item object.

27. The apparatus of claim 26 further comprising:
means for filtering the mobile event items based on content parameters; and
wherein means for providing for presentation of the mobile event items and the service event items includes means for providing for presentation of filtered mobile event items.
